(19) United States
(12) Patent Application Publication
(10) Pub. No.: US 2007/0290740 A1
(43) Pub. Date: Dec. 20, 2007

(54) Current Mirror Arrangement

(75) Inventor: Jakob Jongsma, Graz (AT)

Correspondence Address: FISH & RICHARDSON PC, P.O. BOX 1022, MINNEAPOLIS, MN, 55440-1022, US

(73) Assignee: Austriamicrosystems AG, Unterpremstatten (AT)

(21) Appl. No.: 11/574,207

(22) PCT Filed: Aug. 31, 2005
(86) PCT No.: PCT/EP05/09398

§ 371 Date: Feb. 23, 2007

(30) Foreign Application Priority Data
Sep. 1, 2004 (DE) 10 2004 042 354.7

(51) Int. Cl. G05F 1/10

(52) U.S. Cl. 327/543

(57) ABSTRACT

A current mirror arrangement is specified in which two current mirror transistors (2, 3) form a current mirror. Two cascode transistors (11, 12) are connected up to the two current mirror transistors (2, 3) to form a cascode stage. The cascode transistors (11, 12) in each case comprise a plurality of partial transistors (13, 14, 15; 16, 17, 18) connected up to one another in series with respect to their controlled paths. As a result it is possible to connect the connecting node of the current mirror transistors to a connecting node between two partial transistors (14, 15). This in turn brings about an increase in the input voltage range for a current source (4) that provides an input current for the current mirror.

The present invention relates to a current mirror arrangement with cascode stage in accordance with the preamble of patent claim 1.

Current mirrors are known as basic circuits of semiconductor circuit technology and described in terms of their construction with transistors for example in the document U. Tietze, Ch. Schenk: “Halbleiter-Schaltungstechnik” [“Semiconductor Circuit Technology”], 10th edition 1993, pages 62 and 63.

Current mirror circuits can be employed in various circuit technologies or integration processes, such as, for example, in bipolar circuit technology or in metal insulator semiconductor (MIS) circuit technology.

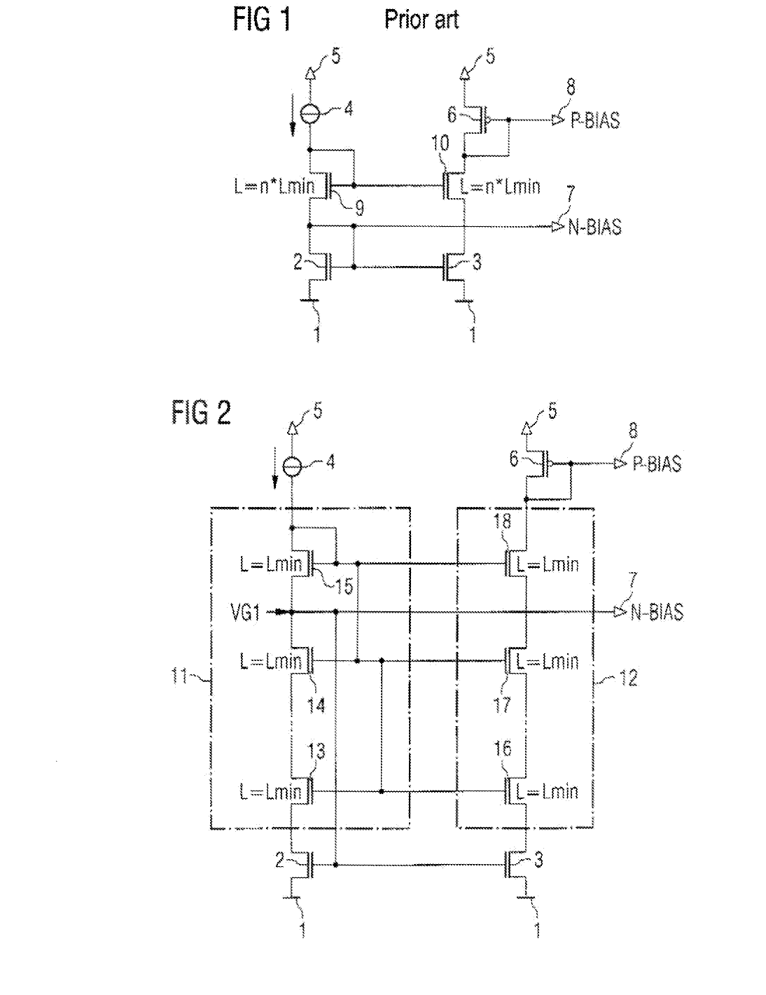

FIG. 1 shows a known current mirror with cascode stage according to the generic type. The actual current mirror comprises two transistors 2, 3 connected to a reference potential terminal 1 in each case by one terminal of their controlled paths. In the present case, the transistors 2, 3 of the current mirror are in each case of the n conductivity type, that is to say N-channel transistors. The control terminals of the transistors 2, 3 are also referred to as gate and are directly connected to one another. The input-side transistor 2 of the current mirror has a controlled path connected to the gate terminal of the current mirror transistor 2 by a first terminal and to the reference potential terminal 1 by a further terminal. That terminal of the controlled path of the transistor 2 which is connected to the gate terminal of the transistor 2 is connected to a supply potential terminal 5 via the controlled path of a first cascode transistor 9 and via a current source 4. The current source 4 represents an input current to be fed to the current mirror arrangement with cascode.

The output-side transistor 3 of the current mirror from FIG. 1 also has a controlled path, which is connected, on the one hand, to the reference potential terminal 1 and, on the other hand to a terminal of a controlled path of a further transistor 6 via a second cascode transistor 10. The further transistor 6 is connected to the supply potential terminal 5 of the circuit by a further terminal of its controlled path and has a p conductivity type. The further transistor 6 is of the opposite conductivity type with respect to the current mirror translators 2, 3, but also relative to the cascode transistors 9, 10. The control terminal of the transistor 6 is connected to that terminal of its controlled path which is also connected to the cascode transistor 10.

The cascode stage of the current mirror arrangement from FIG. 1 comprises the two cascade transistors 9, 10, of which the first cascode transistor 9 is connected into the input-side current path between current source 4 and transistor 2. The second transistor 10 of the cascade stage is connected into the output-side current path of the arrangement between the further transistor 6, which is connected up as a diode, and the output-side current mirror transistor 3. The transistors 9, 10 themselves in turn form a current mirror with one another, the first cascode transistor 9 forming the input-side transistor of the cascode current mirror 9, 10.

The circuit in accordance with FIG. 1 can be used for generating two complementary bias signals. Output terminals 7, 8 are formed for this purpose. A first output terminal 7 for providing a bias signal NBIAS is formed at the common gate terminal of the current mirror transistors 2, 3 and thus at the connecting node between the current mirror transistor 2 and the cascode transistor 9. A further output terminal 8 is formed with the control terminal of the further transistor 6 and with the connecting node between further transistor 6 and second cascode transistor 10. The output terminal 8 serves as an output for tapping off a bias signal PBIAS for p-Mos devices. The bias signal NBIAS that can be tapped off at the first output terminal serves for driving MOS devices of the n conductivity type. The two bias signals PBIAS, NBIAS may be used, for example, for setting the operating point of further devices that are not depicted in FIG. 1.

In the case of the circuit from FIG. 1, in the input-side current path 4, 9, 2 when providing an input signal for the current mirror by means of current source 4, the source-drain voltages of the transistors 2, 9 have to be subtracted from the supply voltage provided in order to determine the remaining voltage range for the input signal. This remaining modulation range or input voltage range is also referred to as headroom.

It is an object of the present invention to specify a current mirror arrangement which affords a larger modulation range at its input for the same supply voltage and at the same time can have a construction with a cascode stage.

The object is achieved according to the invention by means of a current mirror arrangement developed to the effect that the first and the second cascode transistor in each case comprise a plurality of partial transistors connected up to one another in series with respect to their controlled paths.

according to the principle proposed, the first cascode transistor, which together with the first current mirror transistor forms a common input current path, is divided into a plurality of partial transistors. The partial transistors in each case have controlled paths, which form a series circuit with one another. Likewise, the second cascode transistor is also subdivided into a plurality of partial transistors. These partial transistors, too, are connected up to one another in a series circuit with respect to their controlled paths.

According to the principle proposed, it is possible to connect the common control terminal of the current mirror transistors at one of the intermediate nodes formed by the division into partial transistors in the first cascode transistor. Accordingly, the common control terminal of the current mirror transistors no longer need necessarily be connected between the first cascode transistor and the first current mirror transistor, but rather may be connected between partial transistors.

As a result, the control voltage is reduced by a specific number of partial voltages dropped across the controlled paths of the partial transistors. Consequently, the input voltage range, or headroom of the current mirror is in turn increased for the same supply voltage. Conversely, with a corresponding object being formulated, with the principle proposed, it is possible to reduce the supply voltage for the same modulation range.

In the present case, the term cascode transistor is not understood in the narrower sense, rather the principle proposed can also be applied to other current mirror arrangements comprising a plurality of stacked transistors, for example, to so-called Wilson current mirrors.

In one preferred embodiment, the first cascode transistor forms a cascode stage with respect to the first current mirror transistor. Correspondingly, the second cascode transistor forms a cascode stage with respect to the second current mirror transistor.

Preferably, the common control terminal of the first and of the second current mirror transistor is connected to a connecting node. In this case, the connecting node is formed between two partial transistors of the first cascode transistor.

It is further preferred, in the case where the first cascode transistor is divided into more than two partial transistors, to make provision for providing the connecting node between only one partial transistor on the one hand, and all the remaining partial transistors of the first cascode transistor apart from said one partial translator, on the other hand. Accordingly, only one partial transistor of the first cascode transistor is connected, with respect to its controlled path, between the connecting node and an input of the current mirror or a current source connected there. Said one partial transistor is preferably to be operated in saturation, while the remaining partial transistors are permitted to operate in their linear range.

According to a further, preferred embodiment, an output transistor is connected at that side of the second cascode transistor which is remote from the second current mirror transistor. An output terminal is formed at the output transistor, said output terminal serving for outputting a first current. A further output terminal for providing a second current is formed at that connecting node to which the common control terminal of the two current mirror transistors is connected. As a result, it is possible to provide two different bias signals for semiconductor devices of complementary conductivity types. Thus, when the circuit is embodied using MOS circuit technology, by way of example, it is possible to provide a bias signal NBIAS for n-MOS devices and a PBIAS signal for p-MOS devices. In this case according to the principle proposed, complementary bias currents are distinguished by high correspondence. As a result of the high correspondence between NBIAS and PBIAS signals, transistors of complementary conductivity types can be operated at respectively corresponding operating points and/or circuits having high symmetry and good matching can be produced.

The partial transistors of the first cascode transistor preferably each have a control terminal, all the control terminals of the partial transistors being connected to one another. Likewise, the control terminals of the partial transistors of the second cascode transistor are also all connected to one another. The control terminals of the partial transistors of the first cascode transistor and the control terminals of the partial transistors of the second cascode transistor are preferably likewise connected to one another.

Preferably, the output transistor, the second cascode transistor and the second current mirror transistor are arranged in a common output current path in a series circuit, the common current path being connected between a supply potential terminal and a reference potential terminal.

The first cascode transistor and the first current mirror transistor are likewise preferably arranged in a common input current path.

The output transistor is preferably connected up as a diode.

The conductivity type of the output transistor, on the one hand, and the conductivity type of the two cascode transistors, on the other hand, are preferably complementary to one another. In this case, the cascode transistors preferably have the same conductivity type as the current mirror transistors.

The first cascode transistor and the first current mirror transistor are preferably arranged together with a current source in a common input current path. In this case, the current source represents that current which is to be fed to the current mirror. The current source, the first cascode transistor and the first current mirror transistor are preferably connected in a series circuit between a supply and a reference potential terminal. In this development of the invention, the cascode transistors are preferably in each case connected between a current mirror transistor, on the one hand, and the output transistor or the current source on the other hand.

In another, preferred embodiment of the present invention, a feedback current mirror is formed by the second cascode transistor and the first cascode transistor. In this case, the second cascode transistor is connected up as a diode. In this case, the second current mirror transistor forms the input-side current mirror transistor with respect to the main current mirror and is therefore connected up as a diode instead of the first current mirror transistor. A Wilson current mirror is accordingly formed in this embodiment. The current mirror arrangement is preferably constructed in an integrated circuit design.

The current mirror arrangement is preferably constructed using so-called complementary metal oxide semiconductor, CMOS circuit technology. The subclaims relate to further details and advantageous developments of the principle proposed.

The invention is explained in more detail below using a plurality of exemplary embodiments with reference to the drawings.

In the figures:

FIG. 1 shows a current mirror arrangement with cascode stage,

FIG. 2 shows a first exemplary embodiment of a current mirror arrangement according to the principle proposed with cascode stage,

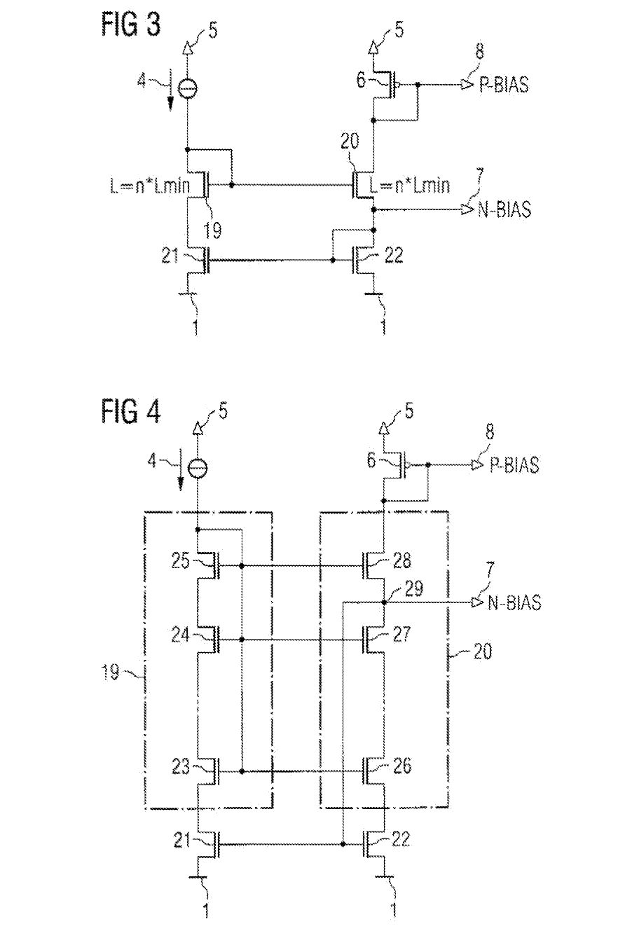

FIG. 3 shows a current mirror arrangement according to Wilson, and

FIG. 4 shows a second exemplary embodiment of a current mirror arrangement according to the principle proposed in the case of a Wilson current mirror.

FIG. 1 shows a current mirror arrangement with cascode stage. The circuit from FIG. 1 has already been explained in the introduction to the description and therefore will not be described again at this juncture.

FIG. 2 shows a current mirror arrangement on the basis of a first exemplary embodiment according to the principle proposed. A first current mirror transistor 2 is provided, which together with a second current mirror transistor 3 forms a current mirror. The controlled paths of the two current mirror transistors 2, 3 are connected to a reference potential terminal 1 by a respective one of their terminals. The control terminals of the current mirror transistors are connected to one another. The further terminal of the controlled paths of the current mirror transistors 2, 3 is connected to a respective cascode transistor 11, 12. The first cascode transistor 11 and the second cascode transistor 12 in each case have a plurality of partial transistors 13, 14, 15; 16, 17, 18 connected up to one another in series with respect to their controlled paths. The partial transistors 13, 14, 15 of the first cascode transistor 11 are formed as MOS transistors in the same way as the two current mirror transistors 2, 3 and together have a channel length which, when added up, corresponds, for example, to that of a conventional cascode transistor 9 from FIG. 1. The control terminals of the partial transistors 13, 14, 15 of the first cascode transistor 11 are connected to one another and to a terminal of the controlled path of the cascode transistor 11 that is not connected to the current mirror transistor 2. Said terminal is additionally connected to a current source 4, which provides an input current for the current mirror. The second cascode transistor 12 likewise comprises a plurality of partial transistors 16, 17, 18 connected up to one another in series with respect to their controlled paths, the control terminals of which partial transistors are likewise connected to one another and to the control terminals of the partial transistors 13, 14, 15 of the first cascode transistor 11. The sum L of the channel lengths Lmin of the individual partial transistors in the case of the second cascode transistor 12 also corresponds for example to the channel length of the second cascode transistor 10 from FIG. 1.

The second cascode transistor 12 is connected between the second current mirror transistor 3 and an output transistor 6. The output transistor 6 is of a p-channel type, while all the remaining transistors 2, 3, 13, 14, 15, 16, 17, 18 are of an n conductivity type. The output transistor 6 is furthermore connected up as a diode. A PBIAS signal can be tapped off at the gate terminal of the output transistor 6, said gate terminal being connected to a terminal of its controlled path. The output thus formed is provided with reference symbol 8. An NBIAS signal 7 can be tapped off at the connecting node VG1 formed between two partial transistors 14, 15 of the first cascode transistor 11. The connecting node VG1 is additionally connected to the common control terminal of the current mirror transistors 2, 3. The connecting node VG1 is separated from the current source 4 by only one partial translator 15. The remaining partial transistors 13, 14 are connected between the connecting node VG1 and the first current mirror transistor 2. Consequently, only one minimum channel length Lmin is formed between the input of the current mirror and the connecting node VG1. As a result, the largest possible modulation range of the voltage across the current source 4 is in turn ensured for a given supply voltage of the circuit. The supply voltage is fed to the current mirror arrangement between a supply potential terminal 5 and the reference potential terminal 1.

The current source 4 and also the partial transistors 13, 14, 15 of the first cascode transistor 11 together with the first current mirror transistor 2 form a comment current path between supply and reference potential terminals 5, 1. A further current path is formed by the output transistor 6, the second cascode transistor 12 and also the second current mirror translator 3, which are likewise connected in a series circuit between the supply potential terminal 5 and the reference potential terminal 1.

The voltage across cascode transistor 11 and current mirror transistor 2 is advantageously reduced as a result of the division of the two cascode transistors 11, 12 into a number of series-connected partial transistors and the connection of the gate terminal of the NMOS current mirror 2, 3 to the source terminal of the topmost partial transistor 15 of the first cascode transistor. This reduction takes place by the sum of the drain-source voltages of the partial transistors 13, 14 below the topmost partial transistor 15 of the first cascode transistor 11. As a result, a larger input voltage range is in turn afforded for the current source 4. This means that the so-called headroom is increased. In this case, the sum of the channel lengths of the partial transistors 13 to 15 corresponds to the total channel length that an individual cascode transistor would have. In this case, the channel lengths of the individual partial transistors are advantageously identical. For reasons of symmetry, the same division is effected in the case of the second cascode transistor as well. The smaller the minimum possible channel length which still meets the respective requirements of the application is in the respective technology, the comparatively greater the input voltage range may be.

The current mirror arrangement in accordance with FIG. 2 additionally provides two bias signals, PBIAS, NBIAS of complementary types; this means that the two bias signals can be used to drive in each case devices of complementary conductivity types, for example for operating point setting. On account of the structure shown and the construction with a cascode stage, the present circuit enables a particularly good correspondence between the two bias signals, thereby ensuring a high circuit symmetry and a good matching of driven symmetrical or complementary devices. The principle of the circuit from FIG. 2 with the divided transistors and the input voltage that is increased as a result is independent, however, of the bias generation that is provided in an additionally advantageous manner here.

By comparison with the circuit in FIG. 1, the complete drain-source voltage of a cascode transistor need not be added to the gate voltage of the current mirror.

Whereas the partial transistor 15 between connecting node VG1 and current source 4 is preferably to be operated in saturation, the remaining partial transistors need not be operated in saturation but rather may be operated in their linear range.

It goes without saying that transistors of the complementary conductivity type can also be used in modifications of the circuit shown.

Moreover, it is possible, as an alternative, to insert further partial transistors.

FIG. 3 shows a Wilson current mirror, to which the principle proposed can also be applied. In this case, as in the case of the cascode principle, two current mirror transistor pairs are stacked one above another, although one of the two current mirrors is formed as a feedback current mirror in the case of the Wilson current mirror. Accordingly, a forward current mirror comprising the transistors 19, 20 and a reverse current mirror comprising the current mirror transistors 21, 22 are provided in the case of the circuit from FIG. 3. The first transistor 19 and the first current mirror transistor 21 form a series circuit together with the current source 4. The first transistor 19 is connected up as a diode. The second transistor 20 together with the second current mirror transistor 22 likewise forms a series circuit. The second current mirror transistor 22 is connected up as a diode. The second transistor 20 and the first current mirror transistor 21 are not connected up as diodes. The transistors 19, 20, 21, 22 from FIG. 3 replace the transistors 2, 3, 11, 12 from FIG. 2; for the rest, the circuit is unchanged and will not be described again here. If the transistors 19, 20 are then in turn divided into partial transistors, this results in the advantages already described for a Wilson current mirror.

A circuit developed in this way is shown in FIG. 4. The circuit from FIG. 4 largely corresponds in terms of construction and functioning to that from FIG. 3 and in this respect will not be described again. The transistors 19, 20 from FIG. 3 are divided into partial transistors 23, 24, 25; 26, 27, 28 in the case of FIG. 4. In this case, the partial transistors are in turn connected in series with one another in pairs with respect to their controlled paths. The control terminals of all the partial transistors 23 to 28 are connected to one another in a common control terminal, which is connected to the circuit node formed between the partial transistor 25 and the current source 4. Accordingly, the transistors 19, 20 comprising partial transistors 23 to 28 from the forward current mirror of the circuit arrangement from FIG. 4. The reverse current mirror is formed by the transistors 22, 21, their common control connection being connected to a connecting node 29 connected between two partial transistors of the transistor 20 according to the principle proposed. In the present case, the point of connection chosen was the connecting node between the partial transistors 27, 28 analogously to the circuit from FIG. 2 in order to obtain a largest possible voltage range as headroom.

All the circuits shown also function in the complementary variant, in which case all the NMOS transistors are replaced by PMOS devices and vice versa.

It goes without saying that the principle of a current mirror arrangement shown is not restricted to the exemplary embodiments shown, rather the latter serve only for illustrative purposes.

### LIST OF REFERENCE SYMBOLS

1 Reference potential terminal
2 Current mirror transistor
3 Current mirror transistor
4 Current source
5 Supply potential terminal
6 Output transistor
7 Output translator
8 Output transistor
9 Cascode transistor
10 Cascode transistor
11 Cascode transistor
12 Cascode transistor
13 Partial transistor
14 Partial transistor
15 Partial transistor
16 Partial transistor
17 Partial transistor
18 Partial transistor
19 Transistor
20 Transistor
21 Current mirror transistor
22 Current mirror transistor
23 Partial transistor
24 Partial transistor
25 Partial transistor
26 Partial transistor
27 Partial transistor
28 Partial transistor
29 Connecting node

1. An arrangement, comprising:
a current mirror comprising a first current mirror transistor and a second current mirror transistor;
a first cascode transistor in series with the first current mirror transistor, the first cascode transistor comprising a plurality of partial transistors connected in series; and
a second cascode transistor in series with the second current mirror transistor, the second cascode transistor comprising a plurality of partial transistors in series.

2. The arrangement of claim 1, wherein:
the first current mirror transistor includes a first control terminal connected to a connecting node; and
the second current transistor includes a second control terminal connected to the first control terminal and to the connecting node, the connecting node being between a first and a second partial transistor of the partial transistors in the first cascode transistor and a third and a fourth partial transistor of the partial transistors in the second cascode transistor.

3. The arrangement of claim 2, wherein all of the partial transistors of the first cascode transistor except one partial transistor of the first cascode transistor are connected in series between the connecting node and the first current mirror transistor.

4. The arrangement of claim 1, further comprising:
an output transistor connected to the second cascode transistor, the output transistor comprising a first output configured to provide a first current.

5. The arrangement of claim 4, wherein the output transistor, the second cascode transistor, and the second current mirror transistor are arranged in a series circuit in a common current path between a supply and a reference potential terminal.

6. The arrangement of claim 4, wherein terminals of the output transistor are connected to form a diode.

7. The arrangement of claim 4, wherein a conductivity type of the output transistor is different from a conductivity type of the first and second cascode transistors and the first and second current mirror transistors.

8. The arrangement of claim 1, wherein the partial transistors of the first cascode transistor and the partial transistors of the second cascode transistor each have a control terminal, and the control terminals of the partial transistors are connected.

9. The arrangement of claim 1, further comprising:
a current source connected in a current path with the first cascode transistor and the first current mirror transistor.

10. The arrangement of claim 1, wherein:
the second cascode transistor and the first cascode transistor form a current mirror,
the second cascode transistor is connected as a diode, and
the first and second cascode transistors and the first and second current mirror transistors form a Wilson current mirror.

11. The arrangement of claim 1, wherein the arrangement comprises an integrated circuit.

12. The arrangement of claim 1, wherein the first and second current mirror transistors and the first and second cascode transistors comprise complementary metal oxide semiconductor circuit transistors.

13. The arrangement of claim 9, wherein the current source, the first cascode transistor, and the first current mirror transistor are connected in a series between a supply terminal and a reference potential terminal.

14. The arrangement of claim 4, further comprising a second output configured to provide a second current at that connecting node.
